(19) United States
(12) Patent Application Publication
(10) Pub. No.: US 2026/0359346 A1
(43) Pub. Date: Nov. 12, 2026

(54) GENERATING UNIVERSAL ENTITY REPRESENTATIONS

(71) Applicant: Pinterest, Inc., San Francisco, CA (US)

(72) Inventors: Anirudhan Badrinath, Cupertino, CA (US); Nikil Pancha, San Francisco, CA (US); Kousik Rajesh, South San Francisco, CA (US); Alexander Yang, San Francisco, CA (US); Prabhat Agarwal, Mountain View, CA (US); Jaewon Yang, Campbell, CA (US); Jiajing Xu, Palo Alto, CA (US); Charles Joseph Rosenberg, Cupertino, CA (US)

(21) Appl. No.: 19/201,712

(22) Filed: May 7, 2025

(51) Int. Cl. G06F 16/438; G06F 16/435

(52) U.S. Cl. CPC G06F 16/438; G06F 16/435

(57) ABSTRACT

Methods, systems, and apparatus, including computer programs encoded on computer storage media, for processing data. One of the methods includes accessing a heterogeneous graph; for each node: determine a set of neighbor nodes; extracting features from the node and each neighbor node; generating an aggregated representation for the node, wherein generating the aggregated embedding for the node comprises: processing features of the node and each neighbor node using respective machine learning models, wherein the machine learning models are trained based on a plurality of contrastive learning tasks; performing a retrieval operation that selects a plurality of media objects, the retrieval operation including: identifying a target node associated with the query; identifying one more nodes corresponding to media objects that are similar to a media object corresponding to the target node; and providing the one or more media objects as recommendations to a user device for presentation.

### BACKGROUND

This specification relates to data processing and in particular to using representation learning to generate entity representations.

User interactions with content discovery systems, for example, often rely on recommender systems to generate personalized recommendations relevant to the user or the user's interests. Quickly identifying content of interest can be challenging particularly when the recommender system has a large volume of content for potential recommendations and a large number of users for which recommendations can be provided.

Representation learning generally relates to the task of learning latent vectors to represent entities. Representation learning is typically used to improve various recommender systems. Conventional recommender systems use machine learning or artificial intelligence models to generate recommendations, for example, of product or other content.

Different representation learning techniques have been developed for different types of signals. For example, graph neural networks are specialized in understanding relationships among entities in graphs while sequence models can capture sequences of activities.

### SUMMARY

This specification describes technologies for generating entity representations using a large-scale framework that leverages different signal sources to generate universal representations of different entity types. The representations can then be used by various downstream applications including recommendation systems that provide different types of content recommendations based on the entity representations.

In particular, this specification describes the construction and sampling of a heterogeneous graph having multiple node and edge types. Entity embeddings are generated from features of a target node and features of one or more neighbors identified from the sampling. Image and text features can be separately processed for the target node and the none or more neighbors to generate an aggregated embedding for the node. Contrastive learning tasks can be modeled to incorporate different signal types into the embedding. The contrastive learning tasks are propagated back to the embedding generation process, e.g., to adjust model weights based on respective loss function minimizations.

In general, one innovative aspect of the subject matter described in this specification can be embodied in methods that include the actions of accessing a heterogeneous graph comprising nodes of a plurality of node types and edges of a plurality of edge types; for each node: sampling the heterogeneous graph to determine a set of neighbor nodes; extracting features from the node and each neighbor node; generating an aggregated representation for the node by an encoder processing the features, wherein generating the aggregated embedding for the node comprises: processing features of the node and each neighbor node using respective machine learning models, wherein the machine learning models are trained based on a loss function defined for a plurality of contrastive learning tasks; performing a retrieval operation that selects a plurality of media objects, the retrieval operation including: identifying a target node associated with the query; identifying one more nodes corresponding to media objects that are similar to a media object corresponding to the target node, the identifying including evaluating the aggregated representation for the target node; and providing the one or more media objects as recommendations to a user device for presentation.

Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The subject matter described in this specification can be implemented in particular embodiments so as to realize one or more of the following advantages.

Existing systems typically focus on particular types of signals and are not suitable for integrating other types of signals. By contrast, the described framework integrates graph neural networks with content-based models and user sequence models by using multiple contrastive learning tasks to effectively process graph data, user sequence data, and content signals. Downstream applications such as recommendation systems can generate more accurate recommendations that are highly relevant to users because the framework generates embeddings that capture multiple signal sources.

Incorporating these additional signals means that the embeddings are generated using increased data, increased types of data sources, and increased variety in data sources. This provides for better performance of downstream tasks, for example, in retrieval or recommendation tasks.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which a recommendation engine provides recommendation services.

FIG. 2 is a block diagram illustrating a portion of an example heterogeneous graph.

FIG. 3 is a block diagram of an example architecture for generating universal representations.

FIG. 4 is a flow diagram of an example process for generating a content embedding.

FIG. 5 is a flow diagram of an example process for content retrieval.

FIG. 6 is a block diagram of an example pipeline for providing end-to-end delivery of results using universal representations.

FIG. 7 is a block diagram of an example computing system.

Like reference numbers and designations in the various drawings indicate like elements.

### DETAILED DESCRIPTION

This specification relates to technologies for generating universal representations for entities. Entities can include, for example, images, collections of images, items, queries, and users. Different techniques for representational learning focus on specific types of signals. For example, graph neural networks (GNN's) can be specialized in understanding the relationships among entities in graphs. Sequence models can capture how a user's interests evolve over time by encoding a sequence of user activities. Content-based models convert textual and image content into embeddings. However, these individual models typically do not perform across signal types. The representation framework described in this specification integrates multiple signal sources to learn and generate representations that are universally useful for multiple distinct downstream applications.

There are several challenges to such a unified framework. GNN's are difficult to scale, especially for sampling neighbors and fetching node features across billions of nodes and edges on billions of training examples. Additionally, GNNs may need to further extend at scale to accommodate heterogeneity, i.e., different node and edge types within the graphs. Another challenge is the incorporation of graph information, content signals, and user activity sequences in a single representation. Graphs and sequences are distinct data types that typically rely on different model architectures. Furthermore, it is challenging to learn representations that can effectively support multiple applications.

To overcome these challenges, the unified framework described below includes infrastructure for sampling neighbors and fetching neighbors features in a GNN efficiently for large scale of training and inference data. The infrastructure can support graphs with billions of entities and host heterogeneous graphs with multiple node and edge types. Additionally, the framework incorporates a contrastive learning framework to formulate tasks covering the different data types in a unified manner. The contrastive learning tasks include an entity-entity task (from graphs), an entity-feature task (from content), and a user-entity task (from user activity sequences).

### Recommender System Architecture

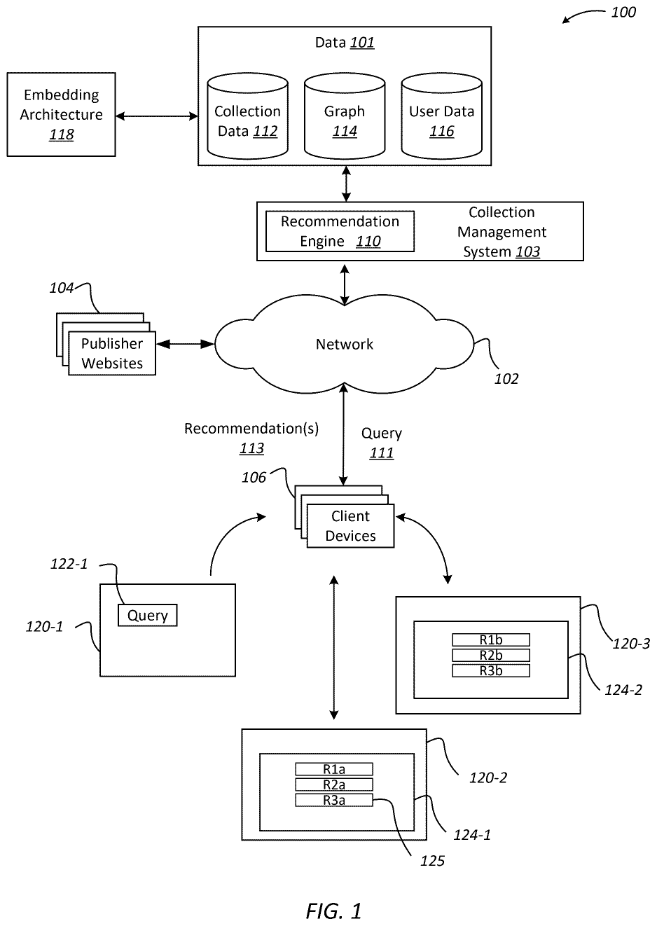

FIG. 1 is a block diagram of an example environment 100 in which a collection management system 103 manages data 101 and a recommendation engine 110 of the collection management system 103 provides recommendation services. The collection management system 103 can include a network of computing devices. A network 102, which can be, for example, a local area network (LAN), wide area network (WAN), the Internet couples the collection management system 103 with publisher websites 104, and client devices 106.

The client devices 106 can be various computing devices including, for example, computers, laptops, tablets, mobile phones etc. that may be used by respective users to interact (e.g., modify or add) with the data 101. For example, a user can use a corresponding client device 106 to create a collection of content that is added to the data 101 and/or associate representations, e.g., individual items of content such as an image, with a collection. Users can use the client devices 106 to add a representation from the client device 106 and/or from publisher websites 104 to data 101, and/or to view representations provided by the collection management system 103, other users, and/or other publisher websites 104. A client device 106 typically includes a user application, such as a web browser or “app,” to facilitate the sending and receiving of data over the network 102. The user application can enable a user to display and interact with representations located on a web page at a website or a local area network location.

The publisher websites 104 provide representations (e.g., images) that are available using the network 102. The data 101 can include links to representations that are provided by the publisher websites 104. An example publisher website 104 is a collection of web pages formatted in hypertext markup language (HTML) that can contain text, graphic images, multimedia content, and programming elements, such as scripts. Each publisher website 104 can be maintained by an entity that manages and/or owns the website.

The collection management system 103 can include one or more computing devices that interact with the client devices 106 over the network 102. The collection management system 103 can maintain and modify the data 101. The data 101 may include, for example, collection data 112, one or more heterogeneous graphs 114, and/or user data 116. The collection data 112 can include collections, representations, and related data that may indicate, among other things, associations between representations and collections.

The system can construct the heterogeneous graph 114 from at least a portion of the collection data 112, for example, as a graph neural network. The heterogeneous graph 114 can be a model of data in the collection data 112. Each node of the heterogeneous graph 114 can correspond to a collection of representations or an individual representation from the collection data 112. Edges of the heterogeneous graph 114 that connect different nodes of the node graph correspond to associations between items or collections of items represented by nodes of the graph. The edges can indicate that a particular representation is associated with specific collections in the collection data 112 or associated with other representations in the collection data 112. Other edge types can indicate user actions with respect to nodes. For example, a user adding a content item to a collection can generate edge data between a node of the representation and a node of the corresponding collection.

The nodes of the heterogeneous graph 114 can be associated with embeddings generated by an embedding architecture 118. The embedding architecture 118, as described in detail below, generates embeddings for nodes in the heterogeneous graph 114 using different features of the associated content represented by the node as well as neighbor node features. In some implementations, the embedder architecture generates embeddings that are then stored in a data structure, for example, with collection data 112 of data 101. At run-time, embedding information can be retrieved directly from the stored embeddings without repeatedly traversing the heterogenous graph 114.

In some implementations, the heterogeneous graph 114 can be saved to cache, for example, a cache of the collection management system 103. Saving or storing the heterogeneous graph 114 to cache may allow for recommendations to be formulated more quickly.

The collection management system 103 can maintain and/or update the user data 116. The user data 116 can include information about users, for example, user interests or information related to past interactions by individuals with the collection management system 103. The user data 116 can include user activities such as user interactions with collections and/or representations in the data 101 as well as user actions to add content to the data 101. The user activities can be maintained in one or more sequences of user activities indicating user activity with respect to time. For example, the user data 116 can indicate a history of a user's interactions with data in the collection data 112, the recommendation engine 110, and/or the collection management system 103. For example, the user data 116 can indicate representations or collections previously viewed or selected by a user. In one or more implementations, the user data 116 can indicate representations that have been recommended to a user and the specific recommended representations that the user has included in the user's collections.

The collection management system 103 can maintain or update the collection data 112. The collection data 112 can include, for example, collections, representations, associations between collections and representations, textual descriptions for representations, textual descriptions for collections, and/or constraints. In some implementations, data in collection data 112 is created and/or modified by users or a source of the representation and/or collection. For example, users can create collections and/or modify collections by interacting with the collection management system 103 using the client devices 106. Additionally, users can cause associations to be added to or removed from representations and collections in the collection data 112.

In some implementations, the collection management system 103 can associate a representation with multiple different collections in response to users requesting to “save” the representation to the collections. In some implementations, users can use the collection management system 103 to create a collection. For example, a user can create a collection for cooking and save representations related to cooking (e.g., images of cooked items, ingredient lists, instructional videos, etc.) to the collection. Other data can be associated with representations or collections, for example, an identification of a user that created the collection, a context, a textual description, a category, supplemental information, and/or one or more scores, e.g., a topic score.

Content items (which can also be referred to as “media objects”) can include various types of content including, for example, documents, images, video, or audio. Content items can include different types of content, e.g., words, phrases, pictures, sounds, and so on, and have associated information such as a description, a link, and/or an image. Content items can be provided by one or more of the publisher websites 104, a user, another party, etc., and stored in the collection data 112. If the content item is provided by a publisher website 104, a link (e.g., URL) to the publisher website can be included in the collection data 112.

The recommendation engine 110 can receive a query 111 that corresponds to one or more nodes in the node graph 114 from content recommendations can be identified. The query 111 can refer to objects in the data 101, such as nodes, representations, users, collections, etc. In some implementations, the query 111 refers to one or more nodes in the node graph, or the query 111 can refer to one or more content items and/or one or more collections that are selected by a user.

In some implementations, the system receives the query 111 from a client device 106. For example, the query 111 can refer to one or more content items that are selected by a user of the client device 106. If the query 111 refers to data in the collection data 112, such as collections and/or representations, the nodes in the node graph 114 that correspond to the collections and/or representation can be determined by the recommendation engine 110.

In some implementations, the system determines the query 111 at least in part on the user data 116. For example, the query 111 can correspond to representations that the user has previously viewed or added to collections associated with the user, as indicated in the user data 116. In some implementations, the query 111 is based on how many times that a user has viewed specific content items or collections, as indicated by the user data 116. For example, the query 111 can include the most frequently viewed content items for a user. In some implementations, the system determines the query 111 based at least in part on a user inputting a textual search string that is provided to the recommendation engine 110. For example, a user may enter the text “hamburgers” in a search box and client device 106, and the recommendation engine 110 can determine the query 111 based on the entered text. The system can identify a target node from the textual query, for example, selecting a target node that is a content item including an image of a hamburger.

The recommendation engine 110 can use the node graph 114 to identify one or more recommendations 113 that are responsive to the query 111. For example, in some implementations, the recommendation engine 110 can traverse the heterogeneous graph 114 using one or more traversal techniques, e.g., random walks, to identify nodes in the heterogeneous graph that are relevant to the node associated with the received query 111.

The recommendation 113 can refer to content in the collection data 112 that corresponds to nodes in the heterogeneous graph 114. For example, representations in the collection data 112 corresponding to the identified nodes in the heterogeneous graph 114. The system can send the recommendation 113 to the client device 106 associated with the query 111 for presentation. Additionally, the system can provide the recommendation 113 to client devices 106 in various ways such as email, text message, news feed, and/or sending representations (e.g., images) of the recommendation 113 for display using an application, etc.

In some implementations, a first presentation 120-1 of a representation 122-1 is presented on a display of a client device 106. The representation 122-1 can be selected by a user using a client device 106 and included in a query 111 that is provided to the recommendation engine 110. For example, the user can select the first representation 122-1 to indicate that the user desires to view recommended content that is similar to the representation 122-1. After receiving the query 111, the recommendation engine 110 can determine a node, e.g., a target node, in the heterogeneous graph 114 that corresponds to the representation 122-1. This node can be a query node from which to formulate a recommendation 113, e.g., based embedding information for the node, Based on the node embedding, the recommendation engine 110 can then determine the recommendation 113 that is provided to the client device 106 for presentation.

The recommendation 113 can include one or more representations 124-1 that are included in a second presentation 120-2 by the client device 106. The user can continue to refine the query or submit an additional query based on the recommendation. For example, a representation R3A 125 of the first plurality of representations 124-1 can be selected and included in a query 111 that is provided to the recommendation engine 110. The recommendation engine 110 can determine a target node in the heterogeneous graph 114 that corresponds to the representation R3A 125. Evaluation of the target node, for example, using embedding information for the node, can be used by the recommendation engine 110 to identify one or more nodes corresponding to recommendations. The recommendation 113 can be provided to the client device 106 and presented in third presentation 120-3 of one or more second representations 124-2 by the client device 106. In some implementations, this process may continue with further queries 111 being provided to the recommendation engine 110 and recommendations 113 being determined by the recommendation engine 110 and sent to the client device 106 for presentation.

In other implementations, instead of, or in addition to, the recommendation engine 110, the collection management system 103 can include a retrieval engine. The retrieval engine can be used to identify one or more nodes based on prior user activity on the content discovery platform. For example, when accessing the content discovery platform (e.g., signing on), a collection of content items can be presented on a user interface. The collection of content items can be selected for inclusion, and provided to the device of the user, based at least in part on the historical activity of the user with content of the platform within a specified time period.

### Heterogeneous Graphs

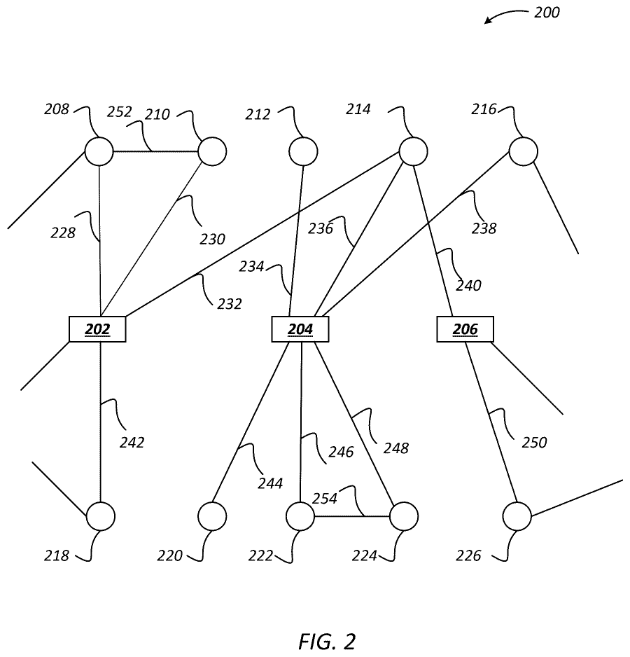

FIG. 2 illustrates an example of a portion of a heterogeneous graph 200 that can be constructed from, and that can model a portion of, collection data, such as collection data 112 of FIG. 1. The portion of the heterogeneous graph 200 includes first nodes 202, 204, and 206. The portion of the heterogeneous graph 200 also includes second nodes 208, 210, 212, 214, 216, 218, 220, 222, 224, and 226. In the example graph portion illustrated by FIG. 2, the first nodes 202, 204, and 206 each represent a collection in the collection data. Each of the second nodes 208, 210, 212, 214, 216, 218, 220, 222, 224, and 226 each correspond to specific representations, e.g., images, video, audio, etc., in the collection data.

In addition, the portion of the heterogeneous graph 200 contains edges 228, 230, 232, 234, 236, 238, 240, 242, 244, 246, 248, and 250 that connect respective first nodes and second nodes. Edges in the heterogeneous graph can be determined based on associations between first nodes and second nodes as indicated in collection data 112. Edges connecting first nodes and second nodes thus correspond to representations and collections as indicated in collection data 112.

A second node can be connected to multiple first nodes. For example, second node 214 is connected to first nodes 202, 204, and 206. This indicates that the representation corresponding to second node 214 is included in the collections represented by first nodes 202, 204, and 206. In some implementations, the heterogeneous graph 200 can contain no edges that connect two first nodes to one another and/or two or more second nodes to one another.

The portion of the heterogeneous graph 200 also includes edges 252, 254, 256 that connect second nodes to each other. For example, nodes 208 and 210 may be images that are related to each other. They can be related, for example, based on a similarity between the two images or by containing similar objects within the respective images.

In some implementations, representations are associated with (or “included in”) collections based on user inputs. For example, a connection between a representation in the collection data and a collection in the collection data may be established by a human user “saving” or otherwise indicating that the representation is to be associated with the collection. Edge 228 is a connection between a first node 202 for a collection and a second node 208 for a representation. Edge 228 can indicate that in the collection data from which heterogeneous graph 200 is generated or constructed, there is an association between the representation and the collection, or that the representation represented by second node 208 has been included in the collection represented by first node 202.

Edges 228, 230, 232, and 242 connect first node 202 with second nodes 208, 210, 214, and 218, respectively, Edge 228 corresponds to an association between a representation in the collection data corresponding to second node 208 being associated with a collection in the collection data corresponding to the first node 202. In addition, edges 230, 232, and 242 correspond to associations between representations in the collection data corresponding to second nodes 210, 214, and 218 being associated with the first node 202 corresponding to a collection in the collection data.

As another example, edges 234, 236, 238, 244, 246, and 248 connect first node 204 to second nodes 212, 214, 216, 220, 222, and 224. These correspond to associations between representations in the collection data corresponding to second nodes 212, 214, 216, 220, 222, and 224 being associated with in the first node 204 corresponding to a collection in the collection data. For example, each second node 212, 214, 216, 220, 222, and 224 may represent media content that has been saved to the collection 204 by a user of the content discovery platform.

In some implementations, one or more pruning techniques are performed on the heterogeneous graph. Different techniques can be used to exclude nodes from the heterogeneous graph. For example, diversity pruning can be applied to the collection data when forming the heterogeneous graph to exclude noisy collections and their associations to representations from being incorporated into the construction of the heterogeneous graph. The diversity pruning process may remove topically diverse first nodes and their edges or data corresponding to topically diverse first nodes and/or their edges. For example, a diversity score for a collection corresponding to a first node may be determined based at least in part on topic scores for representations corresponding to second nodes.

In some implementations, particular entities may be excluded from being incorporated into the heterogeneous graph. For example, entities that were created prior to a defined date may be determined to not meet a criterion and may be excluded from being incorporated into the heterogeneous graph. In some implementations, entities that are not associated with any collection are excluded from being incorporated into the heterogeneous graph. Similarly, entities that are not associated with any other entities, i.e., no edges connect to the node representing the entity, can be excluded as they would be in little use for graph traversal since there are no connected nodes.

As a heterogeneous graph, the graph has nodes that represent different types of entities. One example is a graph for entities of a content discovery platform. The entities can include, for example, users, queries, media content, and boards. For example, the content discovery platform can allow users to engage with content on the platform in various ways. Users can engage with representations of particular media content, for example images or video. The engagement can include exploration of media content on the platform, adding new media content, and organizing media content. For example, a user can create a collection and add various media content to the collection.

In the heterogeneous graph, the edges connecting the nodes can represent user interactions e.g., searches, saves, selections (e.g., clicks), as well as factual relationships, e.g., categorizations and associations. The graph structure allows the platform to comprehensively capture both direct interactions and contextual relationships between entities.

Formally, the heterogeneous graph H can be defined as H=(V, E, T^{v}, T^{e}), where V is the set of nodes v, E is the set of edges, T^{v} is the set of node types, and T^{e} is the set of edge types. Each node v∈V is associated with a node type tᵥ=φ(v) using a node type mapping function φ: V→T^{v} and a set of features xᵥ. Similarly, each edge (u, v)∈E (uv for short) from node u to node v is associated with an edge type r=ψ(u, v) using an edge type mapping function ψ: E→T^{e} and a set of attributes aᵥ.

### Neighbor Sampling in the Heterogeneous Graph

The heterogeneous graph can be used to identify a heterogeneous neighborhood N(u) for a given node u. In web-scale graphs having millions or billions of nodes, sampling all neighbors within a k-hop neighborhood for k>0 is computationally costly or infeasible. Importance-based identification of neighbors provides a robust method to sample high-quality neighborhoods for representation learning in homogeneous graphs. To measure the importance of a node v with respect to node u in graph G the system uses a proximity score s(u, v, G). The proximity score can be defined based on a visit probability of a random walk visiting v when starting from u. The top k nodes with the highest proximity scores then can be used to represent the neighborhood of the node. For example, over a specified number of random walks beginning at a target node, the nodes with higher visit counts can have higher proximity scores indicating the nodes are more important, or more relevant, to the target node.

Additionally, sampling a heterogeneous neighborhood N(u) for a heterogeneous graph with different entity nodes can be done by considering the significance of different relations and node types. Instead of selecting the top k nodes irrespective of type, the system determines how many nodes to select for each node type. Furthermore, unlike for homogeneous graphs, it is important to consider how different edge types encode different kinds of domain knowledge. Thus, subgraphs are defined based on subsets of relations and then the union of neighbors from all such subgraphs are taken.

To take into account different node and edge types, metapaths can be used to modify the random walk with an ordered list of possible edge/note types that can be traversed at each step of the random walk. For instance, a representation→collection→representation metapath indicates a path that must adhere to the first node being an individual representation (such as an image or video representation), the second node being a collection of representations, and the third node again being a representation. This also means that each edge is a representation-collection edge. In some implementations, to improve representational power, a combination of multiple metapaths can be used during a sampling process, i.e., not all of the random walks follow the same metapath pattern. After sampling, the top k nodes can again be identified as neighbors of a starting, or target, node based on importance, e.g., a count of visits to each node in the random walks.

Concretely, for a set of relations R⊆T^{e}, the induced subgraph H_{R} is defined by the edges E_{R}={e|e∈E∧ψ(e)∈R}. Given H_{R} and a source node u, the objective is to identify kₜ nodes of type t with the highest proximity score s relative to u in graph H_{R} to form the neighborhood:

N(u,H_{R})=U_{t∈T}_{^{v}}{v∈V∥{v′∈V|s(u,v′,H_{R})>s(u,v,H_{R})}<kₜ}.

The system can use a forward-push algorithm with an error threshold

$$δ = \frac{1}{B}$$

to approximate the scores and find the neighborhood set N(u, H_{R}). Finally, the system can define multiple subsets R₁, R₂, . . . , Rₙ based on empirical analysis and domain knowledge to construct the neighborhood for a node u in H as:

$$N ( u , H ) = {⋃}_{i = 1}^{n} N ( u , {H}_{{R}_{i}} )$$

This approach allows the system to sample a set of nodes that captures the local neighborhood, considering the importance of different relations and node types.

### Representation Learning Architecture

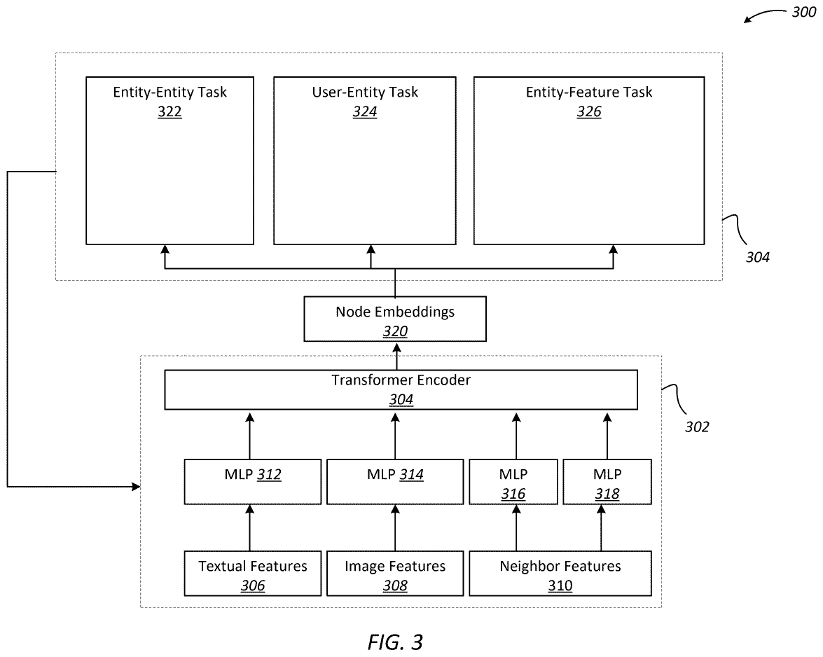

FIG. 3 is a block diagram of an example architecture 300 for generating universal representations. The architecture 300 includes an embedder architecture 302 and a series of contrastive learning modules 304.

The embedder architecture 302 takes the features for each node in the heterogeneous graph and uses transformer encoders to generate an aggregated representation for the node. The representation can be an embedding e.g., a vector or a set of embedding vectors, a semantic identifier, etc. Different entity types have unique characteristics, and thus each type of node has different characteristics. For example, a node for an image representation has different characteristics than a node for a collection. An independent embedder fₜ: Vₜ→R^{d} can therefore be learned for each entity type t∈T^{v}. Transformer encoders 304 are used as the building block for each of these embedders to effectively aggregate the content features of the node u and the features from the local neighborhood N(u, H) of the node u. Each node u has a combination of image features 306 and text features 308. Similarly, each neighbor node can also have neighbor features 310 that include a combination of image features and text features.

The features are separately processed to form an encoding sequence. The sequences are then passed through the transformer encoder 304 layers. The output of the final layer is processed to generate a final node embedding 320. The final node embedding 320 can be an embedding vector that combines information about the node and the individual neighbors.

In greater detail, the text features of the node and the neighborhood are converted into a numerical representation, for example, using a simple share hash-based embedding applied to n-gram tokenized text. This can be considered a middle ground between a standard word embedding and a word embedding using a random hash function as a way to more efficiently generate embeddings for large volumes of text. In other implementations, the text encoding is performed using a text transformer that uses a transformer-based architecture to encode the semantic meaning of the text features. The image features of the node and the neighborhood, respectively, are encoded using a vision transformer model. A vision transformer is an encoder that extracts salient features from visual input. For an input image, a vector representation of the image can be generated that encodes the extracted features. The vision transformer can be based on a convolutional neural network architecture or based on transformers. In some implementations, the base vision transformer is a transformer-based model that contains a single transformer encoder layer, about 12 attention heads, a hidden size of about 768, and a multi-layer perceptron size of 3072.

For a particular node u of type t and its local neighborhood N(u, H), the features of u and neighbor v∈N(u, H) are processed through a multilayer perceptron (MLP) and concatenated to form a sequence. Specifically, a first MLP 312 is used to process the text features of the node, a second MLP 314 is used to process the image features of the node, a third MLP 316 is used to process text features of the neighbor features and a fourth MLP 318 is used to process image features of the neighbor features. Each MLP corresponds to a feedforward neural network having multiple layers of neurons, e.g., at least three layers including an input layer, an output layer, and one or more hidden layers.

The encoded text and image features are processed by the respective MLPs to generate corresponding sequences representing the encoding of the features. The sequences are passed through layers of the transformer encoder 304. The transformer encoder 304 layers include multi-head self-attention. Self-attention is a mechanism used in machine learning to capture dependencies and relationships within input sequences. It allows the model to identify and weigh the importance of different parts of the input sequence by attending to them. Multi-head attention is an extension of the self-attention mechanism that allows the model to focus on different parts of the input sequences simultaneously. This can lead to a greater understanding of the data, in this case the input features of the node and neighborhood.

The transformer encoder 304 and the MLP's 312-318 can learn adjustments to parameter weights based on the results of the contrastive learning modules 304 through back-propagation. For example, gradient descent algorithms can be used to update various model weights based on the outputs of the contrastive learning modules determined in a first forward pass through the architecture. Thus, the embedder architecture 302 can take into account additional signals beyond the graph features in determining the respective embeddings representing nodes and their respective neighbors.

The output from the last layer of the transformer encoder 304 corresponding to a learned classification token is processed through another MLP, followed by L2 normalization to yield the final embedding 320 for the node u, denoted as fₜ(u). The node embeddings 320 are aggregated embeddings that encompass features of both the node and the neighborhood. Thus, for example, for a given node, the embedding can be evaluated to identify one or more of the neighbor nodes in the neighborhood.

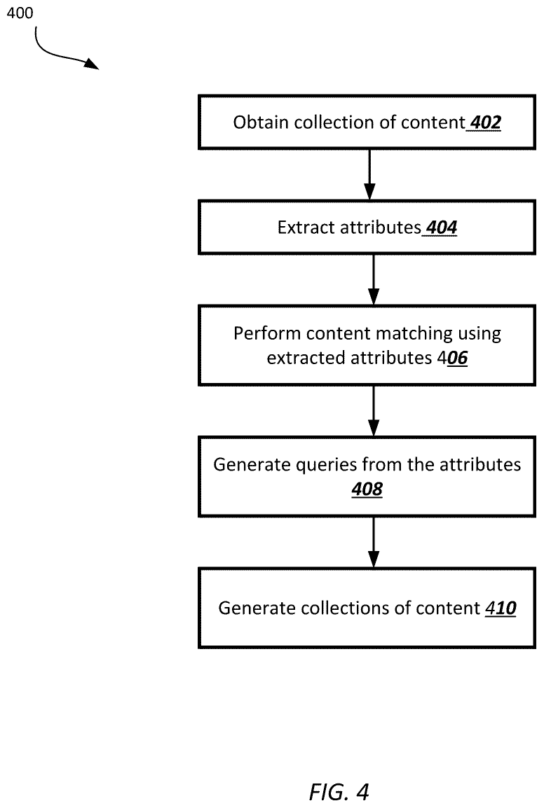

FIG. 4 is a flowchart of an example process 400 for generating embeddings for a node. For convenience, the process 400 will be described as being performed by a system of one or more computers, located in one or more locations, and programmed appropriately in accordance with this specification. For example, a content discovery system including an embedding architecture, e.g., the embedding architecture 302 of FIG. 3, appropriately programmed, can perform the process 400.

The system identifies a node (402). The node is identified from a heterogeneous graph as a target node for processing. The node can be selected as part of a process for generating embedding for each node of the heterogeneous graph, or each node of a pruned heterogeneous graph. Embeddings can be periodically generated, e.g., to reflect changes in the structure of the heterogeneous graph over time.

The system determines the neighborhood for the node (404). The neighborhood, as described above, can be identified by traversing the graph using a specified graph traversal technique. For example, random walks or random walks according to multipath constraints can be used to identify a specified number of neighbor nodes as forming the neighborhood, e.g., based on the relative importance of each neighbor node.

The system separates the features of the node and the neighborhood nodes by feature type (406). The feature types can be, for example, image features and text features.

The system determines a transformer encoder corresponding to a type of the node (408). A different transformer encoder can be used for each type of node in the heterogeneous graph.

In some implementations, each node of the graph is associated with a feature set. The features can be stored, for example, in a key-value store or other database that maps node identifiers to corresponding binarized features sets. The features and/or database can be distributed across multiple storage devices. Thus, for example, when a node is identified, the system can use the node identifier to look up the feature set of the node. This can similarly be performed for each neighbor node of the node. In some other implementations, the features are extracted using one or more suitable feature extraction techniques. Regardless of the technique for feature extraction, the feature extraction can be performed as part of the architecture and implemented for a given collection of entities before or after graph formation.

The system generates respective sequences for the feature of the node and the features of the neighborhood by feature type (e.g., text features and image features) (410). As described above with respect to FIG. 3, the node features are input, by type, to separate MLP's while the neighbor node features are input, again by type, to separate MLP's, e.g., the MLP's 312-318 of FIG. 3. Using the MLP's the node features are processed and concatenated to form a sequence. representing the encoding of the features. The sequences are passed through layers of the transformer encoder e.g., the transformer encoder 304 of FIG. 3.

The system uses the determined transformer encoder for the type of node to generate an aggregated embedding for the node (412) from the generated feature sequences. In some implementations, the transformer encoder has multiple layers that include multi-head self-attention. Self-attention is a mechanism used in machine learning to capture dependencies and relationships within input sequences.

The resulting embedding can be associated with the node in the heterogeneous graph so that various downstream applications using the heterogeneous graph can use the embedding information, for example, when generating recommendations of content represented by nodes of the heterogeneous graph. Specifically, the embedding is an aggregated embedding that includes neighbor embedding information. For example, the aggregated embedding can include a concatenation of the embedding vector of the node and one or more embedding vectors of the neighbor nodes. Thus, evaluation of the embedding for the node can be used to evaluate its neighbors, e.g., for potential recommendation.

### Contrastive Learning

Returning to FIG. 3, the architecture 300 also includes the contrastive learning modules 304. The contrastive learning modules 304 each correspond to a particular contrastive task. The contrastive learning modules 304 include an entity-entity task 322, a user-entity task 324, and an entity-feature task 306.

Contrastive learning is an approach to learning embeddings that can be used to map entities into an embedding space where similar samples (e.g., positive pairs) are close together, while dissimilar samples (e.g., negative pairs) are further apart. Mapping the entities into the embedding space in such a way can improve the performance of downstream applications such as ranking, retrieval, and classification. The architecture 300 aims to achieve several objectives with the generated embeddings. First, the embeddings of similar nodes (of same or different types) should be close together in the embedding space. The embedding should also effectively encode both the content and the local neighborhood of each node. Furthermore, the embeddings should capture the sequence of entities in a user's journey. To achieve these objectives, the architecture 300 uses three types of contrastive tasks: entity-entity, entity-feature, and user-entity.

For each contrastive task, the system is configured to optimize a set of continuous representations in R^{d} that minimize a sampled softmax objective with query-positive pairs. For each query q and positive p pair, the system samples a set of negatives N by sampling random examples (random negatives) and sampling positive examples of other queries in the same batch (in-batch negatives). Given that the in-batch negatives are sampled from a biased distribution based on the training labels, the system can use sample probability correction through estimation of the frequency of each of the nodes Q(v)∝P(v|q) with a countmin sketch. Consequently, based on the vector representations of the query q and a candidate v, the system defines their score function s(q, v)=λ·q^{T}v−log Q(v), applying a correction to account for the sampling bias, where λ is a temperature hyperparameter. Given a query-positive pair (q, p) and sampled negative examples N, the empirical loss function can be computed as:

$$L ( q , p , N ) = - log ( \frac{exp ( s ( q , p ) )}{exp ( s ( q , p ) ) + {\sum }_{n ∈ N} exp ( s ( q , p ) )} )$$

Specifically, an initial set of embeddings for nodes can be generated using a forward pass through the architecture 300. These embedding can be used along with other information, e.g., information on user activity sequences, to compute the corresponding loss functions. Back propagation can be used with respect to the transformer encoder to adjust weights of, for example, the self-attention layers, to minimize particular loss functions. Minimizing the loss function thereby results in embeddings encoding a node and its neighborhood that are mapped to the embedding space such that, for example, similar content items are closer together in the embedding space than dissimilar content items. Moreover, the different tasks and different end use applications may have different notions of similarity that the architecture can take into account, allowing for more versatile uses.

### Entity-Entity Tasks:

One of the most important use cases of low-dimensional embeddings is to provide a measure of similarity between two entities or find similar entities given a query entity. The system can use both supervised and unsupervised techniques to generate positive pairs.

For example, in a content discovery platform an entity can be an image, video, or other media content. In some implementations, the entity can also be a collection of multiple items of content, which may be composed of content of the same or multiple types. For different entities, there can be historical data indicating pairs of entities in which a second entity is selected by a user after viewing the first entity. Conceptually, this can indicate that the user found the two entities to be similar to each other. Similarly, these can be contrasted with negative pairs of entities that are not known to be similar. Based on a set of pairs of entities, contrastive learning can be used to push the embeddings of nodes representing entities known to be similar closer together, i.e., the similarity as measured between the embeddings using, for example, a cosine difference or dot product, is increased. Similarly, the similarity of unrelated entities decreases. The contrastive learning can use a softmax loss to minimize the difference between the embedding prediction of similarity and the known similarity between entities. This is useful, for example, in a downstream retrieval task where the query is a particular content item (corresponding to a particular node) and the system retrieves similar content. Through the back-propagation process, the transformer encoder 304 and the MLP's adjust model weights to reduce this loss function.

The entity-entity contrastive learning task inputs graph edges and engagement data for entity pairs to compute the loss function.

Graph Edges: Given a node u and its sampled neighbor set N(u), the system samples nodes v∈N(u) of type t to construct pairs for the entity-entity task. Although these pairs can cover all combinations of entity types, the process can be simplified by considering only a subset of entity type pairs based on importance and business need. This approach is similar in intention to edge prediction, but it uses a sampled softmax loss instead of the traditional binary cross-entropy loss.

Engagement Data: To better represent the engagement on the content discovery platform, the system can collect pairs of engaged entities from logs (e.g. representation-representation or collection-representation). The system also segments this dataset by dimensions such as promoted content, shoppable content, video, etc. Compared to sampling pairs uniformly from the graph, this allows the system to rebalance different content types in the dataset and assign weights to specific content types if required.

The resulting set of all entity pairs from graph edges and engagement data can be denoted Dₚₐᵢᵣ. For given node types t_{q} and tₚ, the system samples query-positive pairs (q, p) from each data source

$${D}_{p a i r}^{( i )}$$

∈Dₚₐᵢᵣ. For each of these pairs (q, p), the system also randomly samples a corresponding set of negatives N from nodes with type tₚ. The entity-entity pair loss is a weighted sum of the losses for each data source

$${D}_{p air}^{( i )} ,$$

$$L ( {D}_{p a i r} ) = {\sum }_{i} {E}_{( q , p , N ) ∼ {D}_{p a i r}^{( i )}} [ {w}_{i} L ( {f}_{{t}_{q}} ( q ) , {f}_{{t}_{p}} ( p ) , {f}_{{t}_{p}} ( N ) ) ]$$

### Entity-Feature Tasks

To ensure that node embeddings encode both content and local neighborhood information, the system also employs a contrastive task between the entity embedding and the features of the node and its neighbors. The heterogenous graph contains information that is not fully captured through the feature extraction or graph traversal described above with respect to the node features. For example, each node has a neighborhood of nodes. Therefore, for a particular node, evaluating the graph surrounding that node there are neighbors constituting user activity, e.g., what users have done after selecting an entity or other engagements with different entities after that. Thus, the neighborhood can represent a type of similarity space of entities that are likely to lead to similar engagement and reflect user engagement on the content discovery platform.

The objective of the entity-feature task is to capture as much of the neighborhood information in the graph using a contrastive learning task that “learns” the neighborhood of a given entity. Conceptually, the contrastive learning task works to try to push the embeddings of neighbor nodes towards the target node. For example, given an embedding for a particular node, the task takes the features of the neighbors of that entity and the features of the particular node and tries to push those embeddings together so that given a target entity the system can retrieve its features and the features of the neighborhood.

Given a node u and its sampled neighbor set N(u), the task aligns the input features of node u and the sampled set of nodes v∈N(u) with the node embedding, while contrasting against the embeddings of negative examples. The intuition is that by aligning the node embedding with its input features, the task can ensure that the model preserves the content information of the node.

For each input feature type x, the system initializes a multi-layer perceptron (MLP) encoder gₓ(u) as the learned encoding of the feature with type x. Similar to the entity-entity task, the entity-feature contrastive objective improves a sampled softmax loss across a dataset D_{feat} containing nodes u of type tᵤ and a set of negative nodes N sampled from the same type for each u. When the query is the feature encoding gₓ(u) for x∈Xᵤ, the set of all feature types of node u, and the positive and negatives are the embedding of u and N respectively, the entity-feature task loss is provided by:

$$L ( {D}_{feat} ) = {E}_{( u , N ) ∼ {D}_{f e a t}} [ \frac{1}{\vert {X}_{u} \vert} ] {\sum }_{x ∈ {X}_{u}} L ( {g}_{x} ( u ) {f}_{{t}_{u}} ( u ) , {f}_{{t}_{u}} ( N ) )$$

### User-Entity Task

The sequence of a user's engagement on the content discovery platform is a rich source of information that underpins many retrieval and ranking models. To harness this information, the system introduces a “user-entity” contrastive task that allows the system to improve the graph-based representations end-to-end based on user activity.

Intuitively, the objective of the user-entity task is to take entity embeddings and user activity histories and apply sequential objectives, for example, predicting a next entity that the user will engage with. Rather than attempting to increase similarity between similar entities as in the entity-entity task, the user-entity task seeks to increase dot products between entities that are in the user sequence. For example, a user may view image 1 followed by image 2 and then image 3. Given the embedding of image 1, the task aims to increase the user embedding dot product with the next entity embedding, i.e., for image 2. Essentially, this is a prediction of an entity that the user will engage with given a user history sequence. As a consequence, following back propagation, the embeddings are generated for entities that are tuned toward user behavior. This can be used, again as an example, in a retrieval task downstream in determining what entities are relevant to a query entity based on the user actions over a defined time period, e.g., a month or a year.

This approach ensures that the node embeddings capture crucial sequential information from user journeys on the content discovery platform, e.g., the user's interactions with node entities. By providing “contextual” entity embeddings, the system can effectively contrast them with future entities in the sequence, enhancing the system's understanding of user behavior patterns.

To perform the user-entity task, the system initializes a transformer decoder model T with maximum sequence length tₘₐₓ for modeling sequences of user activity. The user sequence is composed of nodes [u₁, . . . , uₜ] and each of the nodes are embedded as P_{τ}=fₜ_{ᵤ}(u_{τ}). The input to the transformer T is the sequence [P₁, . . . , P_{τ}] and the outputs are corresponding “user embeddings” U_{τ}=T([P₁, . . . , P_{τ}]).

Two sequence level objectives can be determined, namely the next action loss and the future action loss. The next action loss simply optimizes the user embedding to predict the next entity embedding, i.e., the query is a user embedding Uₜ at time t and the matching positive is the next entity embedding Pₜ₊₁. Given a sequence dataset D_{seq}, the system samples in-batch negatives N for each batch of sequences. The next action loss is defined as:

$${L}_{next} ( {D}_{s e q} ) = {E}_{( P , N ) ∼ {D}_{s e q}} [ {\sum }_{t = 1}^{{t}_{max} - 1} L ( {U}_{t} , {P}_{t + 1} , {f}_{{t}_{u}} ( N ) ) ] e$$

P denotes the input sequence to the transformer. Note in the above summation, the loss will be padding masked if the length of sequence P is smaller than tₘₐₓ.

For the future action loss, we further sample a time point t′ with user activity

$${u}_{t}^{′}$$

from the time window (tₘₐₓ, tₘₐₓ+Δ) uniformly. The resulting dataset is D_{seq*} with the sequence P, the future positive

$${P\_t}^{′} = f\_ ( t\_u ) ( {u}_{t}^{′′′} ) ,$$

and in-batch negatives N. The future action loss is provided by:

$${L}_{f u t} ( {D}_{s e q *} ) = {E}_{( P , {P}_{t}^{′} , N ) ∼ {D}_{s e q *}} [ {\sum }_{t = 1}^{{t}_{max}} L ( {U}_{t} , {P}_{t}^{′} , {f}_{{t}_{u}} ( N ) ) ] erall Objective .$$

The final loss combines the three objectives with hyper-parameters λₚ, λ_{f}, and λₛ as weights is:

L_{θ}(D)=λₚLₚₐᵢᵣ(Dₚₐᵢᵣ)+λ_{f}L_{feat}(D_{feat})+λₛ[Lₙₑₓₜ(D_{seq})+L_{fut}(D_{seq*})].

This overall loss function can be used to perform the back propagation algorithms, e.g., gradient descent, to adjust the weights of parameters of the MLP's and the transformer encoder to incorporate all three of the contrastive learning tasks when generating entity embeddings.

### Downstream Applications

The resulting embedding space can be used for various downstream applications of the content discovery platform. Downstream applications can include, for example, retrieving one or more entities in response to queries.

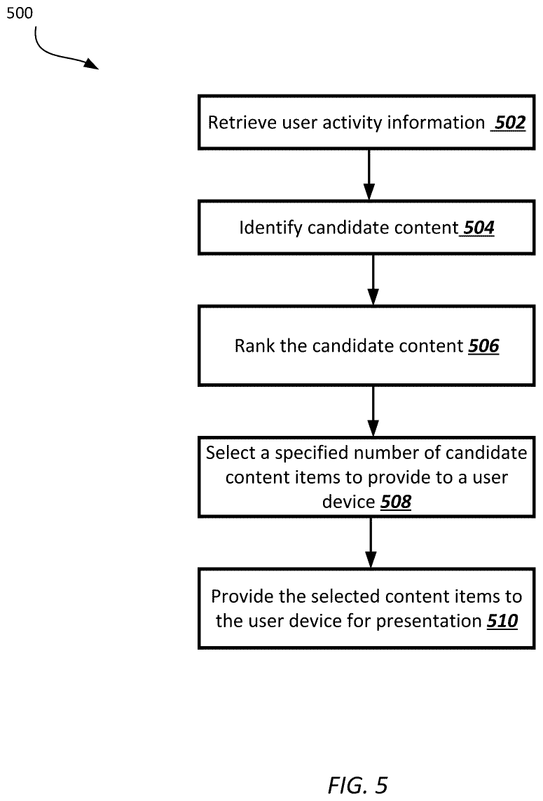

FIG. 5 is a flowchart of an example process for providing recommendations in response to a query. For convenience, the process 500 will be described as being performed by a system of one or more computers, located in one or more locations, and programmed appropriately in accordance with this specification. For example, recommendation engine, e.g., recommendation engine 110 of FIG. 1, of a content discovery system, appropriately programmed, can perform the process 500.

On a content discovery platform, a retrieval application can relate to retrieving a set of content for presentation to a user, for example, on a home user interface when a user accesses the content discovery platform. The content discovery platform determines which content to provide for presentation on a device of the user from a large collection of content.

The system retrieves user activity information (502). The user activity information includes historical activity of the user on the content discovery platform, for example, content the user has interacted with including by selection, adding to a collection, commented or liked, etc. The historical activity information can cover a specified time period, for example, 10 days or 10 months.

The system identifies candidate content (504). The candidate content can correspond to a number of different nodes in the heterogeneous graph and that have embedding representations generated as described above with respect to FIGS. 3-4. As described above, the representations for each node take into account user activity. A retriever engine uses the embedding representations to identify a collection of candidate content items.

The system ranks the candidate content (506). The candidate set may be large and unwieldy in a user interface. For example, the candidate content may include 200 candidate content items. A ranker engine can use additional factors to rank the candidate content items. For example, user history sequences can be used. The user history sequences can include sequences for different types of activity including impressions with content but not engagement, engagements, as well as a full activity sequence that can use the full user history over a specified time period, which can be years in length. All of these sequences have been incorporated into the embeddings based on the sequence learning from the user-entity contrastive learning task. Using the sequence information, each candidate content item can be assigned a corresponding score, which can be used to rank the candidate content items.

The system selects a specified number of candidate content items (508). For example, a top-k candidate content items according to the ranking can be selected. The value of k can be dependent upon the application and various constraints, for example user interface size, the size of rendered content items in the user interface, and the amount of user interface scrolling to allow for the presented content. The user interface size can depend, for example, on whether the user device rendering the user interface is a mobile device or a computer screen.

The system provides the selected candidate content items to the device of the user (510). The system can provide layout information for the user interface indicating an ordering for presenting the candidate content items within the structure of the user interface, e.g., based on the ranking. Depending on the user activity associated with the presented user interface, not all of the selected content items are necessarily rendered on the user device. For example, if the user does not scroll down the user interface, those content items may not be rendered for display. The user can further interact with the content items presented in the user interface, for example, by selecting or otherwise engaging with the content items, e.g., adding one or more content items to a collection of the user.

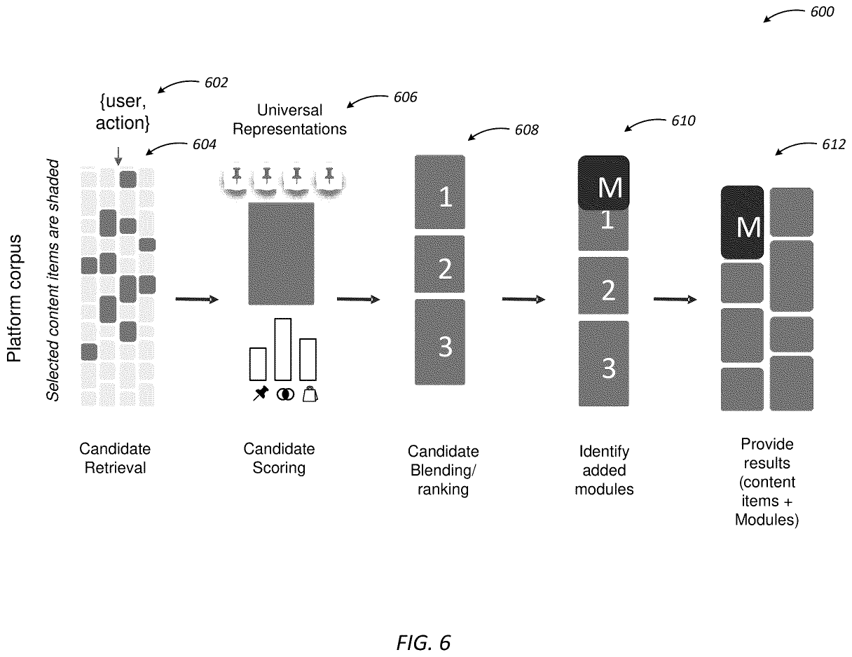

FIG. 6 is a block diagram of an example pipeline 600 for providing end-to-end delivery of results using universal representations. The universal representations can be generated as described above.

A retrieval process can be initiated in response to a user action 602. A user action can include actions such as a user logging onto or initiating a session with the content discovery platform or a specific user action within the content discovery platform such as an interaction with a particular content item, creation of a collection, or user navigation action within the content discovery platform, e.g., navigating to or refreshing a home user interface.

In response to the user action 602, an initial set of candidate content items are identified 604. For example, from the entire corpus of content on the content discovery platform, a specified number of candidates are selected. For example, several thousand content items can be selected as candidates out of billions of content items in the corpus of content. Each candidate corresponds to a particular representation, e.g., in the heterogenous graph. In some implementations, each candidate content item is associated with a unique identifier. The set of candidate content items can therefore be represented by a corresponding set of identifiers.

These initial candidates can be chosen using a variety of suitable techniques. For example, the candidates can be selected based on relevance of the content items to user history information, for example, content the user has interacted with including by selection, adding to a collection, commented or liked, etc. The historical activity information can cover a specified time period, for example, 10 days or 10 months.

The initial candidates are scored 606. Scoring can include obtaining the universal embeddings for each candidate content item. For example, each identifier of a candidate content item is associated or mapped to a corresponding universal embedding, e.g., in a database. The universal embeddings are evaluated to determine how each candidate content item is likely to perform, that is, how likely is the user to interact with the content item if presented. Because the universal embedding of each content item includes a greater context, e.g., not just graph information but also information from the contrastive learning such as user sequence data, the prediction for each content item can correspond to a more accurate indication of user relevance. In some implementations, a machine learning model is used to generate a prediction for each candidate content item. The prediction indicates how likely the user is to interact with a given content item. The model uses the embedding information of the respective candidate content items as input to generate the prediction.

Based on the scores, a content blending process is performed 608. Blending can ensure that particular diversity is satisfied within the candidates regardless of initial score. For example, if 20 content items are to be presented to the user and the top 20 candidate content items are variations of the same content (e.g., images of the same object), the presentation of 20 identical items would not be as useful to the user. Blending can take into account other factors in addition to the scores to generate a resulting ranked set of candidate content items. Depending on the particular application, a specified final number of content items to be returned can be predefined. The blended candidate content items can be ranked in order and the top number of candidate content items can be selected.

Modules to be provided to the user device with the retrieval results can be identified 610. Modules can be structured elements in user interface feed that help enhance the user experience beyond the presentation of content items alone. For example, modules can be used to provide additional context or to provide reminders to the user of prior saved items. This can, for example, help users discover new use cases by providing context regarding retrieval results that may be different than the user expected or can allow users to revisit ideas from prior actions to help the user organize ideas.

At least some of the selected candidate content items and modules are presented to the user 612. In particular, a user interface on the user's device may only present a certain number of content items at a time. The user can then typically scroll, e.g., vertically, to view more content items. The user interface can provide a layout for presenting content items. The user device receives one or more of the selected content items and renders the content items at particular locations within the user interface, e.g., based on blended ranking of the selected content items. Based on the user interaction, e.g., scrolling, additional content items from the selected content items may be provided to the user for presentation. Additionally, one or more of the identified modules can also be provided to the user device for integration into the presented user interface.

In some other implementations, the downstream application is a prediction of user behavior. For example, a prediction of content the user is likely to engage with if presented to the user. The system can identify, for example, similar content to content previously engaged within the user history and then determine, using the node embeddings, one or more nodes representing content that the user is likely to engage with. In yet other implementations, the downstream application is a recommender system that generates one or more recommendations of content to be provided to the user. Other downstream applications can use the universal representations generated by the architecture to perform various types of classification tasks. For example, to filter particular types of content, e.g., prohibited or restricted content, classifying annotations, or classifying content items to different types of interests.

### Training Implementation

The heterogeneous graph is constructed to facilitate scaling of neighbor sampling and feature extraction. Specifically, a graph engine configured to provide efficient on-the-fly neighbor sampling and feature extraction includes a neighbor sampler component and a featurizer component.

In some implementations, the heterogeneous graph is organized using an adjacency list format. Each edge includes metadata like edge weight, and each node holds metadata such as node type and an identifier. The neighbor sampler retrieves the node identifiers for the neighbors N(u) of a query node u, for example, using one or more random walks. In some implementations, the heterogeneous graph is loaded into memory using memory mapping and is implemented in C++. The node sampler can operate on machines with high RAM capacity to support large-scale graphs.

The featurizer is tasked with retrieving the features for the node identifiers provided by the neighbor sampler. To enable on-the-fly featurization, a database composed of a disk-based key-value store can be generated that maps each node identifier to its corresponding binarized feature set. In some implementations, the system can store features even for nodes pruned from the heterogeneous graph. Depending on the size of the feature set for all nodes, the features and database are partitioned across multiple machines. When given a set of node identifiers, the system can perform lookups to retrieve the binarized feature set for each node. These binarized features are then sent back to the system, where they are deserialized into real-valued tensors for training or inference.

For each of the contrastive learning tasks, the system aggregates in-batch and random negatives to improve the quality of the representations. However, as the number of negatives grows, computing the batched similarity function s (Q, n) for a batch of queries Q across all n∈N requires materializing a growing outer product L_{QN}=QN^{T} (of shape (|Q|, |N|)). Since this large matrix of logits L_{QN} is materialized for every task and can be recycled only after the backward pass for L_{Θ} is completed, it can create a significant bottleneck for memory usage.

To remedy this, the system uses an algorithm similar to gradient checkpointing to optimize memory usage and enable significant gains in batch size. The process detaches the query, positive, and negative embeddings and performs a softmax loss computation in chunks, accumulating values the gradient of the loss function with respect to the query, positive, and negative embeddings (i.e., the system does not fully backpropagate through the model each time). Critically, this allows for the large logits matrices to be recycled since their backward pass (i.e., to compute the gradient of the loss with respect to the logits) has been completed. After all the loss computation has been completed, the system backpropagates the gradient from the query, positive, and negative embeddings to the model parameters. This can significantly reduce memory usage, while not adding any more backward passes through the model.

### Inference Implementation

To generate representations across all entities, the system performs daily offline batch inference. Although our heterogeneous graph can be served substantially in real time, offline batch inference offers notable benefits, including greatly reduced costs, maintenance, and oversight. For inference, the system collects edges and constructs a graph daily. The system then deploys the neighbor sampler and feature store machines, alongside GPU inference workers, to efficiently execute forward passes of the input embedders. With a heterogeneous graph containing billions of nodes, the system horizontally scales the infrastructure and inference machines to accommodate inference for billions of entities per day. For entities pruned from the graph or lacking edges, the system can impute zeros for their neighbor features.

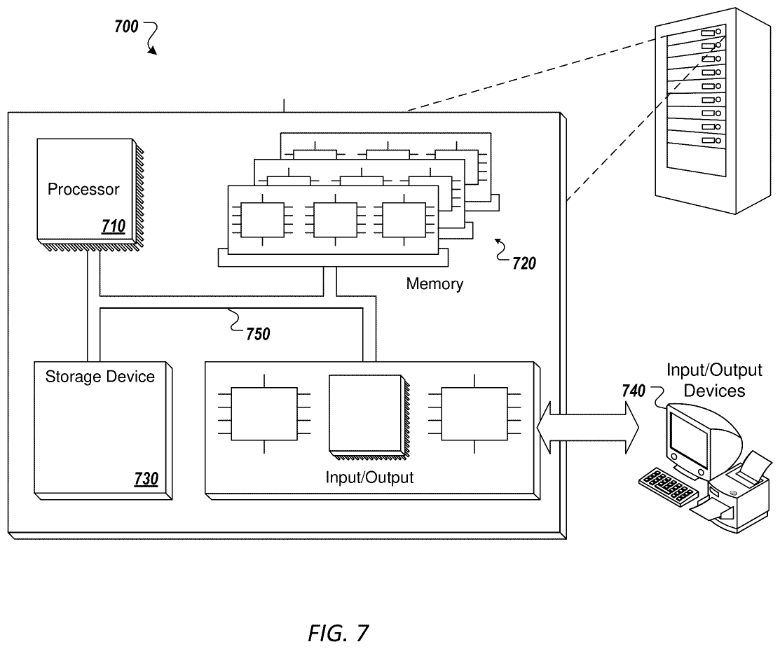

FIG. 7 is a block diagram of an example computer system 700 that can be used to perform operations described above. The system 700 includes a processor 710, a memory 720, a storage device 730, and an input/output device 740. Each of the components 710, 720, 730, and 740 can be interconnected, for example, using a system bus 750. The processor 710 is capable of processing instructions for execution within the system 700. In some implementations, the processor 710 is a single-threaded processor. In another implementation, the processor 710 is a multi-threaded processor. The processor 710 is capable of processing instructions stored in the memory 720 or on the storage device 730.

The memory 720 stores information within the system 700. In one implementation, the memory 720 is a computer-readable medium. In some implementations, the memory 720 is a volatile memory unit. In another implementation, the memory 720 is a non-volatile memory unit.

The storage device 730 is capable of providing mass storage for the system 700. In some implementations, the storage device 730 is a computer-readable medium. In various different implementations, the storage device 730 can include, for example, a hard disk device, an optical disk device, a storage device that is shared over a network by multiple computing devices (e.g., a cloud storage device), or some other large capacity storage device.

The input/output device 740 provides input/output operations for the system 700. In some implementations, the input/output device 740 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices. Other implementations, however, can also be used, such as mobile computing devices, mobile communication devices, set-top box television client devices, etc.

Although an example processing system has been described in FIG. 7, implementations of the subject matter and the functional operations described in this specification can be implemented in other types of digital electronic circuitry, or in computer software, firmware, or hardware, including the structures disclosed in this specification and their structural equivalents, or in combinations of one or more of them.

In this specification the term “engine” will be used broadly to refer to a software based system or subsystem that can perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments of the attached claims and the embodiments described above, the following embodiments are also innovative:

Embodiment 1 is a method, the method comprising: accessing a heterogeneous graph comprising nodes of a plurality of node types and edges of a plurality of edge types; for each node: sampling the heterogeneous graph to determine a set of neighbor nodes; extracting features from the node and each neighbor node; generating an aggregated representation for the node by an encoder processing the features, wherein generating the aggregated embedding for the node comprises: processing features of the node and each neighbor node using respective machine learning models, wherein the machine learning models are trained based on a loss function defined for a plurality of contrastive learning tasks; performing a retrieval operation that selects a plurality of media objects, the retrieval operation including: identifying a target node associated with the query; identifying one more nodes corresponding to media objects that are similar to a media object corresponding to the target node, the identifying including evaluating the aggregated representation for the target node; and providing the one or more media objects as recommendations to a user device for presentation

Embodiment 2 is the method of embodiment 1, wherein the extracted features are separated by feature types, the processing the extracted features comprising: processing features for each feature type for the node and processing features for each feature type for the neighbor nodes using respective multi-layer perceptron models to generate respective sequences; inputting the respective sequences to the \encoder to generate the aggregated representation for the node, the aggregated representation comprising an embedding vector that includes information for the node and for each neighbor node.

Embodiment 3 is the method of any one of embodiments 1 through 2, wherein the plurality of contrastive learning tasks comprise an entity-entity learning task that evaluates similarity between pairs of positive entities and pairs of negative entities of the heterogeneous graph such that a measure of distance between similar entities is reduced.

Embodiment 4 is the method of any one of embodiments 1 through 3, wherein wherein the plurality of contrastive learning tasks comprise an entity-feature task that that evaluates node embeddings encoding both content of the node and information for neighbor nodes as compared to the representations of negative node examples such that a distance between a node representation and its neighbor node representation is reduced.

Embodiment 5 is the method of any one of embodiments 1 through 4, wherein the plurality of contrastive learning tasks comprise an user-entity task that evaluates a sequence of user engagements relative to the nodes of the heterogeneous graph such that a prediction of a next entity in a user sequence is predicted.

Embodiment 6 is the method of any one of embodiments 1 through 5, wherein each of the contrastive learning tasks is associated with a corresponding task loss function, wherein the loss function is a combination of the task loss functions, and wherein the machine learning models are trained by adjusting weights for parameters using one or more back-propagation algorithms such that representations are generated that reduce the loss function.

Embodiment 7 is the method of any one of embodiments 1 through 6, wherein in response to obtaining the query, the method further comprises: using the query to identify the target node of the nodes; retrieving the aggregated representation of the first node; extracting neighbor node information from the aggregated representation; evaluating the embedding information for each neighbor node to identify one or more neighbor nodes responsive to the query; and retrieving one or more media items represented by the one or more neighbor nodes; and providing the one or more media items to a user device for presentation. Embodiment 8 is a system comprising: one or more computers and one or more storage devices storing instructions that are operable, when executed by the one or more computers, to cause the one or more computers to perform the method of any one of embodiments 1 to 7.

Embodiment 9 is a computer storage medium encoded with a computer program, the program comprising instructions that are operable, when executed by data processing apparatus, to cause the data processing apparatus to perform the method of any one of embodiments 1 to 7.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method comprising:
accessing a heterogeneous graph comprising nodes of a plurality of node types and edges of a plurality of edge types;
for one or more nodes of the heterogeneous graph:
sampling the heterogeneous graph to determine a set of neighbor nodes;
extracting features from the node and one or more neighbor nodes;
generating an aggregated representation for the node by an encoder processing the features, wherein generating the aggregated representation for the node comprises:
processing features of the node and the one or more neighbor nodes using respective machine learning models, wherein the machine learning models are trained based on a loss function defined for a plurality of contrastive learning tasks, the contrastive learning tasks being associated with respective data types to generate a unified node embedding that incorporates graph information, content signals, and user activity sequences associated with the node;
performing a retrieval operation that selects a plurality of media objects, the retrieval operation including:
identifying a target node associated with a query;
using the node embeddings to identify one more nodes corresponding to media objects that are similar to a media object corresponding to the target node, the identifying including evaluating the aggregated representation for the target node; and
providing the one or more media objects as recommendations to a user device for presentation.

2. The method of claim 1, wherein the extracted features are separated by feature types, the processing the extracted features comprising:
processing features for one or more feature types for the node and processing features for one or more feature types for the neighbor nodes using respective multi-layer perceptron models to generate respective sequences;
inputting the respective sequences to the encoder to generate the aggregated representation for the node, the aggregated representation comprising an embedding vector that includes information for the node and for one or more neighbor nodes.

3. The method of claim 1, wherein the plurality of contrastive learning tasks comprise an entity-entity learning task that evaluates similarity between pairs of positive entities and pairs of negative entities of the heterogeneous graph, wherein the entity-entity learning task reduces a measure of distance between similar entities.

4. The method of claim 1, wherein the plurality of contrastive learning tasks comprise an entity-feature task that evaluates node embeddings encoding both content of the node and information for neighbor nodes as compared to the representations of negative node examples, wherein the entity-feature task reduces a distance between a node representation and its neighbor node representation.

5. The method of claim 1, wherein the plurality of contrastive learning tasks comprise a user-entity task that evaluates a sequence of user engagements relative to the nodes of the heterogeneous graph, wherein the user-entity task predicts a next entity in a user sequence.

6. The method of claim 1, wherein the contrastive learning tasks are associated with a corresponding task loss function, wherein the loss function is a combination of the task loss functions, and wherein the machine learning models are trained by adjusting weights for parameters using one or more back-propagation algorithms such that representations are generated that reduce the loss function.

7. The method of claim 1, wherein in response to obtaining the query, the method further comprises:
using the query to identify the target node of the nodes;
retrieving the aggregated representation of the first node;
extracting neighbor node information from the aggregated representation;
evaluating the embedding information for one or more neighbor nodes to identify one or more neighbor nodes responsive to the query; and
retrieving one or more media items represented by the one or more neighbor nodes; and
providing the one or more media items to a user device for presentation.

8. One or more non-transitory computer-readable storage media encoded with instructions that, when executed by one or more computers, cause the one or more computers to perform operations comprising:
accessing a heterogeneous graph comprising nodes of a plurality of node types and edges of a plurality of edge types;
for one or more nodes of the heterogeneous graph:
sampling the heterogeneous graph to determine a set of neighbor nodes;
extracting features from the node and one or more neighbor nodes;
generating an aggregated representation for the node by an encoder processing the features, wherein generating the aggregated representation for the node comprises:
processing features of the node and one or more neighbor nodes using respective machine learning models, wherein the machine learning models are trained based on a loss function defined for a plurality of contrastive learning tasks, the contrastive learning tasks being associated with respective data types to generate a unified node embedding that incorporates graph information, content signals, and user activity sequences associated with the node;
performing a retrieval operation that selects a plurality of media objects, the retrieval operation including:
identifying a target node associated with a query;
using the node embeddings to identify one more nodes corresponding to media objects that are similar to a media object corresponding to the target node, the identifying including evaluating the aggregated representation for the target node; and
providing the one or more media objects as recommendations to a user device for presentation.

9. The non-transitory computer-readable storage media of claim 8, wherein the extracted features are separated by feature types, the processing the extracted features comprising:
processing features for one or more feature types for the node and processing features for one or more feature types for the neighbor nodes using respective multi-layer perceptron models to generate respective sequences;
inputting the respective sequences to the \encoder to generate the aggregated representation for the node, the aggregated representation comprising an embedding vector that includes information for the node and for one or more neighbor nodes.

10. The non-transitory computer-readable storage media of claim 8, wherein the plurality of contrastive learning tasks comprise an entity-entity learning task that evaluates similarity between pairs of positive entities and pairs of negative entities of the heterogeneous graph, wherein the entity-entity learning task reduces a measure of distance between similar entities.

11. The non-transitory computer-readable storage media of claim 8, wherein the plurality of contrastive learning tasks comprise an entity-feature task that evaluates node embeddings encoding both content of the node and information for neighbor nodes as compared to the representations of negative node examples, wherein the entity-feature task reduces a distance between a node representation and its neighbor node representation.

12. The non-transitory computer-readable storage media of claim 8, wherein the plurality of contrastive learning tasks comprise a user-entity task that evaluates a sequence of user engagements relative to the nodes of the heterogeneous graph, wherein the user-entity task predicts a next entity in a user sequence.

13. The non-transitory computer-readable storage media of claim 8, wherein the contrastive learning tasks are associated with a corresponding task loss function, wherein the loss function is a combination of the task loss functions, and wherein the machine learning models are trained by adjusting weights for parameters using one or more back-propagation algorithms such that representations are generated that reduce the loss function.

14. The non-transitory computer-readable storage media of claim 8, wherein in response to obtaining the query, the method further comprises:
using the query to identify the target node of the nodes;
retrieving the aggregated representation of the first node;
extracting neighbor node information from the aggregated representation;
evaluating the embedding information for one or more neighbor nodes to identify one or more neighbor nodes responsive to the query; and
retrieving one or more media items represented by the one or more neighbor nodes; and
providing the one or more media items to a user device for presentation.

15. A system comprising:
one or more computers and one or more storage devices storing instructions that are operable, when executed by the one or more computers, to cause the one or more computers to perform operations comprising:
accessing a heterogeneous graph comprising nodes of a plurality of node types and edges of a plurality of edge types;
for one or more nodes of the heterogeneous graph:
sampling the heterogeneous graph to determine a set of neighbor nodes;
extracting features from the node and one or more neighbor nodes;
generating an aggregated representation for the node by an encoder processing the features, wherein generating the aggregated representation for the node comprises:
processing features of the node and one or more neighbor nodes using respective machine learning models, wherein the machine learning models are trained based on a loss function defined for a plurality of contrastive learning tasks, the contrastive learning tasks being associated with respective data types to generate a unified node embedding that incorporates graph information, content signals, and user activity sequences associated with the node;
performing a retrieval operation that selects a plurality of media objects, the retrieval operation including:
identifying a target node associated with a query;
using the node embeddings to identify one more nodes corresponding to media objects that are similar to a media object corresponding to the target node, the identifying including evaluating the aggregated representation for the target node; and
providing the one or more media objects as recommendations to a user device for presentation.

16. The system of claim 15, wherein the extracted features are separated by feature types, the processing the extracted features comprising:
processing features for one or more feature types for the node and processing features for one or more feature types for the neighbor nodes using respective multi-layer perceptron models to generate respective sequences;
inputting the respective sequences to the encoder to generate the aggregated representation for the node, the aggregated representation comprising an embedding vector that includes information for the node and for one or more neighbor nodes.

17. The system of claim 15, wherein the plurality of contrastive learning tasks comprise an entity-entity learning task that evaluates similarity between pairs of positive entities and pairs of negative entities of the heterogeneous graph, wherein the entity-entity learning task reduces a measure of distance between similar entities.

18. The system of claim 15, wherein the plurality of contrastive learning tasks comprise an entity-feature task that evaluates node embeddings encoding both content of the node and information for neighbor nodes as compared to the representations of negative node examples, wherein the entity-feature task reduces a distance between a node representation and its neighbor node representation.

19. The system of claim 15, wherein the plurality of contrastive learning tasks comprise a user-entity task that evaluates a sequence of user engagements relative to the nodes of the heterogeneous graph, wherein the user-entity task predicts a next entity in a user sequence.

20. The system of claim 15, wherein the contrastive learning tasks are associated with a corresponding task loss function, wherein the loss function is a combination of the task loss functions, and wherein the machine learning models are trained by adjusting weights for parameters using one or more back-propagation algorithms such that representations are generated that reduce the loss function.
